(19) United States
(12) Patent Application Publication
(10) Pub. No.: US 2014/0193543 A1
(43) Pub. Date: Jul. 10, 2014

(54) DECORATIVE HOLLOW CHOCOLATE CONFECTION WITH IMPROVED WRITABILITY

(71) Applicant: Alexander Vigneri, Rochester, NY (US)

(72) Inventor: Alexander Vigneri, Rochester, NY (US)

(21) Appl. No.: 14/150,426

(22) Filed: Jan. 8, 2014

Related U.S. Application Data
(60) Provisional application No. 61/750,464, filed on Jan. 9, 2013.

(51) Int. Cl. A23G 1/54; A23G 1/30

(52) U.S. Cl. CPC A23G 1/54; A23G 1/305
USPC 426/87; 426/103; 426/303; 426/233

(57) ABSTRACT

A chocolate confection has a surface that is coated to absorb an edible dye, the surface of the chocolate confection having a coarse sugar coating formed from one or more layers of a first solution having a high sugar to water ratio and a finish sugar coating applied over the coarse sugar coating and formed from one or more layers of a second solution having a low sugar to water ratio.

### CROSS-REFERENCE TO RELATED APPLICATIONS

Priority is claimed from U.S. Provisional Patent Application Ser. No. 61/750,464 filed Jan. 9, 2013 entitled “DECORATIVE HOLLOW CHOCOLATE CONFECTION WITH IMPROVED WRITABILITY” in the name of Alexander Vigneri and incorporated herein in its entirety.

### FIELD OF THE INVENTION

The present invention relates to coated chocolate confections that can be written upon, following manufacture.

### BACKGROUND OF THE INVENTION

Confections have long been enjoyed by people of all ages. The J. S. Fry & Sons company of Bristol, England created the first mass produced chocolate Easter egg in 1873, followed soon after by the Cadbury Company, also of England. Since that time, numerous process improvements have been made, including spin or book coating for the creation of hollow chocolate confections.

Dogliotte, in U.S. Pat. No. 3,961,089 teaches a method using a hinged mold to create a hollow chocolate egg. After chocolate is coated onto both halves of the mold, the more recently coated half is inverted into contact with the bottom half such that a welding takes place between the two halves.

Lee refers to a spin-molded hollow chocolate confection in U.S. Pat. No. 6,406,732. After deposition of an amount of chocolate less than that which would fill the mold, the mold is sealed and spun to coat the mold cavity and create a hollow chocolate form.

In U.S. Pat. No. 2,851,365, Perrozzi teaches sugar coating, or panning, of chocolate centers. This is done for the purpose of maintaining shape and preserving the properties of the chocolate, such as those properties affecting taste.

Cooling after molding is taught by the Capol company in a publication named “Process of Hard Sugar Coating on Chocolate Coated Centers.” The specifications call out cooling overnight at 50 degrees Fahrenheit. This is favorable for solid chocolate objects, but does not take into account necessary properties for panning hollow chocolate objects. Additionally, the panning solution is specified as being between 75 and 85 degrees Fahrenheit. This range works well for solid chocolate objects, but does not take into account the properties of hollow chocolate objects.

Naor, in U.S. Pat. No. 6,299,374, describes a marker with edible inks for use on many food stuffs. Use of the markers of the invention on many foods is called out. However, there is no teaching of improving the surface characteristics of confections to improve writability. Smearing or bleeding of color can result. Typically, an icing comprising powdered sugar coats the confection. This icing provides disorganized sugar crystals that promote bleeding of marking inks.

Smearing of applied colorants is an undesirable characteristic that can be costly to prevent. Practices to reduce smearing can include extending the drying time needed for dyed confections, which adds to the processing time and increases the amount of area needed for temporary storage of colored confections. While there are a multitude of methods for coating and forming chocolate, there has been no ability to create a writable chocolate confection with improved writability that minimizes smearing.

### SUMMARY OF THE INVENTION

A coated hollow molded chocolate object is described, comprising a gas-filled center, chocolate walls surrounding said gas-filled center, a rough sugar coating on the exterior surface of said chocolate walls, and a finish sugar coating on the exterior surface of the rough sugar coating wherein said finish sugar coating accepts edible dyes. The process for creating the coated hollow molded chocolate object is also described.

Prior to and during the coating operation, hollow molded chocolate objects are subject to many factors that can cause deformation of the shape of the hollow molded chocolate object. Care must be taken to insure that these factors are accounted for, so that they do not deform the hollow molded chocolate object. These factors include the temperature of hollow molded chocolate object after it has been molded, the force of insertion of hollow molded chocolate objects into the panning drum, the temperature of air from blowers directed into the panning drum, the temperature of a rough sugar coating solution deposited into the panning drum, particularly during the initial stages of the panning operation, and the speed of rotation of the panning drum. All these factors must be controlled so that panning can occur without deforming hollow molded chocolate objects.

The method of the present invention provides a hollow chocolate confection with a surface that accepts dye readily and allows the dye to set quickly. The prepared surface exhibits reduced smearing over conventional methods.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

Embodiments of the invention will now be described with reference to the drawings in which:

FIG. 1 shows a cross section of a mold used for molding hollow molded chocolate objects;

FIG. 2 shows a chocolate spinning machine;

FIG. 3 shows a cross section of a coated hollow molded chocolate object;

FIG. 4 shows a panning machine;

FIG. 5 is a flow chart of the panning method used in the invention; and

FIG. 6 shows a marker transferring dye to the coated surface of the invention.

### DETAILED DESCRIPTION OF THE INVENTION

In the context of the present disclosure, “writability” is defined as the capacity of an object to receive edible dyes. “Improved writability” is defined as not only the capacity to receive edible dyes, but for those dyes to become quickly colorfast to the surface of the object without objectionable migration across the surface. Smearing is also minimized.

Forming a molded chocolate confection is a multi-step process. Various techniques and apparatus have been developed and improved over the years for providing a decorative hollow chocolate confection. Additional steps are necessary to form and maintain the hollow confection and to provide improved writability.

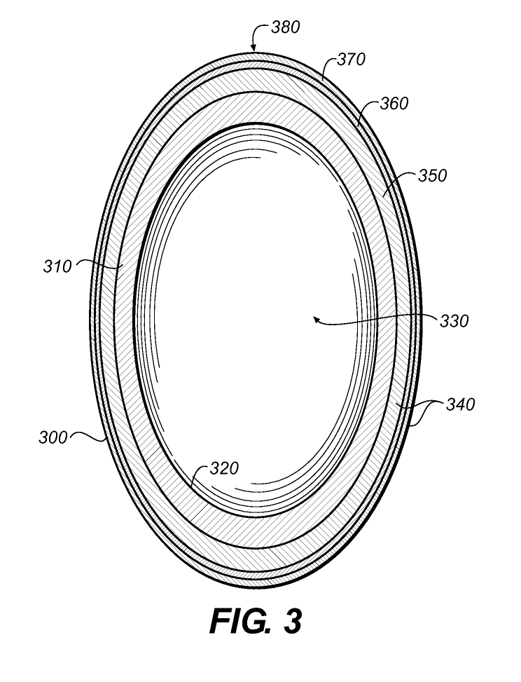

“Panning” as used in this disclosure is the process for coating an object with sugar. “Panning” and “coating” are used interchangeably and it will be understood that both terms are meant to call out the operation whereby an object, such as a hollow molded chocolate object 320 in FIG. 3, is formed having an outer shell of sugar.

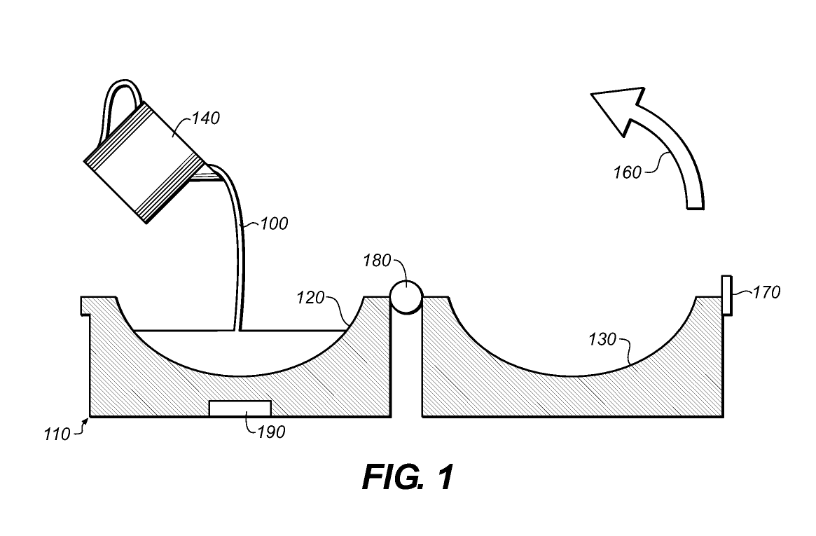

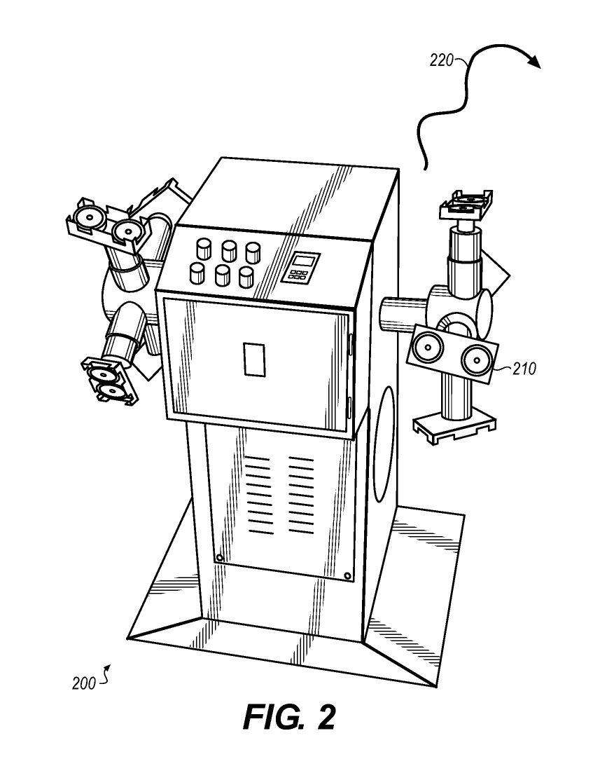

FIGS. 1 and 2 show processes and equipment used for forming a hollow chocolate confection. As shown in FIG. 1, the process begins when liquid chocolate 100 is placed in mold 110. In this embodiment, mold 110 is of the type commonly called a book or spin mold. With the concave portion 120 of mold 110 facing upward, liquid chocolate 100 is directed into concave portion 120 of mold 110 by pouring liquid chocolate 100 from vessel 140 or forcing the liquid chocolate from a nozzle (not shown).

When a predetermined amount of liquid chocolate 100 is placed into concave portion 130 of mold 110, the concave portion 130, which does not contain liquid chocolate 100, is rotated into position, as shown by arrow 160, over filled concave portion 120 and set in place in contact with concave portion 120, so that the mold can be sealed by latch 170.

In practice, liquid chocolate 100 must be tempered to produce the desired properties. The tempering process provides a uniform crystalline structure that creates a smooth surface with improved structural strength after cooling. The preferred tempering temperature varies according to the type of chocolate. After tempering and prior to molding, pure liquid chocolate 100 has a temperature of about 89-90 degrees F. (32 degrees C.) for dark chocolate, about 86-87 degrees F. (30 degrees C.) for milk chocolate, and about 82-83 degrees F. (28 degrees C.) for white chocolate.

With book mold 110 closed, concave portion 130 not containing liquid chocolate 100 has been rotated on hinge 180 attaching the two concave portions 120 and 130 such that they are in a desired position for forming the molded hollow confection with a minimum of misregistration. Setting in place is accomplished by latch 170, but can also be accomplished by a plurality of means such as clips, bolts or screws. Pressure is applied by the means for setting in place, so that mold 110 is sealed and liquid chocolate 100 does not leak out of mold 110.

Once mold 110 is loaded with liquid chocolate 100 and sealed, it is attached to spin machine 200 by means of attachment structure 190, as shown in FIG. 2. Latch 210 on spin machine 200 secures mold 110 to spin machine 200. Other well known means for attachment such as bolts, screws and cinching belts can be used. Spin machine 200 moves the mold through space in an irregular arc indicated by arrow 220 such that liquid chocolate 110 is transferred from its initial position in concave portion 120 of mold 110 to all positions around the inside of the periphery of the mold cavity formed by concave portions 120 and 130. For the purposes of this example, mold 110 is described as a single cavity mold, but one skilled in the art will understand that mold 110 can be a multiple cavity mold.

The temperature of the mold material comprising mold 110 is less than that of liquid chocolate 100. The mold material temperature is approximately 10 degrees Fahrenheit cooler than the chocolate being molded. The temperature of mold 110 can be assumed to be the ambient temperature around the mold; optionally, means for heating or cooling can be provided (not shown). As mold 110 spins and liquid chocolate 100 moves about the interior of the mold, liquid chocolate 100 cools and solidifies against the surface of the mold cavity formed by concave portions 120 and 130. As further cooling occurs, more of the liquid chocolate 100 solidifies against the previously solidified chocolate, thickening the chocolate walls of the molded object.

FIG. 3 is a cross sectional view of coated hollow molded chocolate object 320 and shows the condition where all liquid chocolate 100 has solidified into solid chocolate 300. Walls 310 of hollow molded chocolate object 320 have reached their maximum thickness, leaving a hollow gas-filled center 330. In most cases, gas-filled center 330 comprises air, but it will be understood that other gases may be captured when hollow molded chocolate object 320 is formed in other atmospheres. Spin machine 200 ceases spinning sometime after all liquid chocolate 100 has solidified into solid chocolate 300, which typically takes 8 to 15 minutes.

Hollow molded chocolate object 320, a chocolate egg in one embodiment, must be cooled prior to panning This helps to prevent cracking where there is a large temperature differential with the panning solution. In a preferred embodiment, hollow molded chocolate objects 320 are removed from mold 110, either manually or by an automated process, and are placed on drying trays.

Excessive cooling can cause the hollow walls to become too brittle for subsequent processing. According to an embodiment of the present invention, hollow molded chocolate object 320 is typically cooled overnight, so that the hollow molded chocolate object 320 stabilizes at room temperature, typically 65 to 70 degrees. This temperature is higher than that conventionally used, so that the walls of the hollow molded chocolate object 320 are not cooled to a point of brittleness. Flexibility of walls 310 is maintained by the higher temperature so that some flexibility is maintained for the panning operation.

Thickness of walls 310 of hollow molded chocolate object 320 must be controlled. This is achieved by measuring the amount of liquid chocolate 100 that is placed in mold 110. Too little liquid chocolate 100 will create hollow molded chocolate objects 320 that are too fragile to withstand the panning process. Too much liquid chocolate 100 will create hollow molded chocolate objects 320 that are heavy and difficult to chew, and can cause uneven distribution of solid chocolate 300 on walls 310 comprising hollow molded chocolate object 320. Additionally, too much liquid chocolate 100 will make hollow molded chocolate object 320 more expensive due to use of excess and unnecessary liquid chocolate 100. In a preferred embodiment, the volume of liquid chocolate 100 inserted into mold 110 is between 30 and 60 percent of the total volume of the mold cavity. Note that percentages may differ for different types of chocolate.

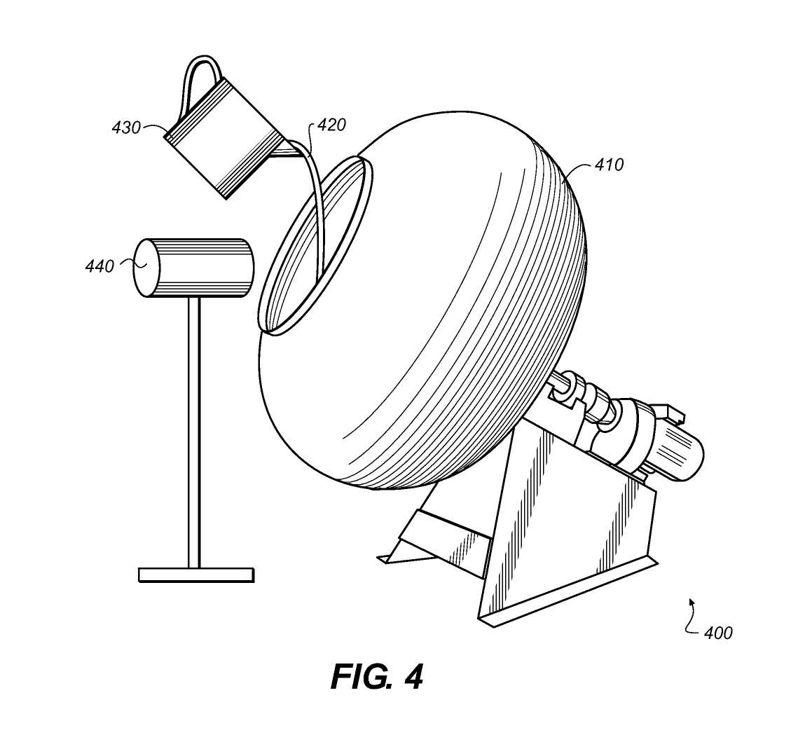

Once extracted and cooled, the hollow molded chocolate objects 320 are gently inserted into panning machine 400 shown in FIG. 4. Care is taken to insure that the hollow molded chocolate objects 320 are not inserted with enough force to break, dent or scuff the molded objects 320. Whether molded chocolate objects 320 are inserted individually by hand or manually with a scoop, or by some mechanical contrivance (not shown), at no time will forces generated by lateral or vertical movement exceed the strength of the walls of the molded chocolate object. The force exerted by inserting the molded object into the panning machine is limited by the type of chocolate and also by the shape and thickness of the walls of the hollow molded chocolate object.

Once a plurality of molded chocolate objects have been inserted into panning machine 400, panning drum 410 rotates. After application of gum arabic or a sugar solution, first coating solution 420 is added. Second coating solution 520 (not shown) is added later, as described below. First coating solution 420 and second coating solution 520 comprise sugar, water, and optionally corn syrup and colorant. First coating solution 420 and second coating solution 520 are heated to 220 to 230 degrees Fahrenheit, until just boiling and then are cooled to a lower temperature before being inserted into the panning drum 410. Boiling concentrates first coating solution 420 and second coating solution 520 by removing water and causing previously granular sugar crystals to saturate or supersaturate first coating solution 420 and second coating solution 520. According to an embodiment, the temperature of first coating solution 420 is lowered to between 65 and 75 degrees Fahrenheit prior to being added to panning drum 410 to accommodate the low mass and strength of the hollow molded chocolate objects 320 as opposed to solid objects. In particular, the temperature of first coating solution 420 must be lowered so that walls 310 of hollow molded chocolate object 320 do not melt due to heat transfer from first coating solution 420 to the low mass of walls 310.

According to one embodiment, the temperature in panning drum 410 is lowered relative to temperatures used in conventional practice. Temperatures approaching the melting point of the chocolate used for hollow molded chocolate objects 320 weaken walls 310 of the objects. Hollow molded chocolate objects 320 must be panned at a lower temperature than solid chocolate objects because there is less mass to dissipate heat and less compressive resistance against impact forces. The temperature in the drum is lowered so that the shape of the objects will be maintained in the panning operation. Conventional panning operations maintain temperature in the drum as high as possible without melting the molded chocolate objects so that the coating operation occurs as quickly as possible. According to one embodiment, the temperature in the drum is lowered by a range of 10 to 25 degrees Fahrenheit from the maximum temperature used for panning solid molded chocolate objects of the same size and shape and chocolate composition. According to one embodiment, this temperature is between 60 and 75 degrees Fahrenheit. When first coating solution 420 cools further in panning drum 410, the sugar crystals are predisposed to become closely organized on the surface of the hollow chocolate molded objects 320 to form coating 340. This close organization of crystals facilitates writability by minimizing bleeding when edible inks are applied.

In conventional practice, the speed of rotation of panning drum 410 is maximized to provide maximized contact between first coating solution 420 and all portions of solid molded chocolate objects. In an embodiment of the invention, first coating solution 420 is added to panning drum 410 by means of vessel 430. The rotational speed of panning drum 410 is slowed from that used with solid molded chocolate objects. The slower speed of rotation provides for lower impact forces during collisions between the hollow molded chocolate objects 320. This is of particular value because walls 310 of hollow molded chocolate objects 320 are less resistant to impact forces than the outer surfaces of solid chocolate objects. The preferred speed of rotation for panning hollow molded chocolate objects is 10 to 20 percent slower than the maximum speed for solid molded chocolate objects of the same size and shape and chocolate composition. According to an embodiment of the present invention, the speed of rotation is between 35 and 40 revolutions per minute.

Care must be taken to maintain the shape of hollow molded chocolate objects 320 through the panning operation. The temperature of hollow molded chocolate objects 320, the force of insertion of hollow molded chocolate object 320 into panning drum 410, the temperature of air from of blower 440 (FIG. 4), the temperature of rough sugar coating solution 420 and the speed of rotation of panning drum 410 must be controlled so that panning can occur without deforming hollow molded chocolate objects 320.

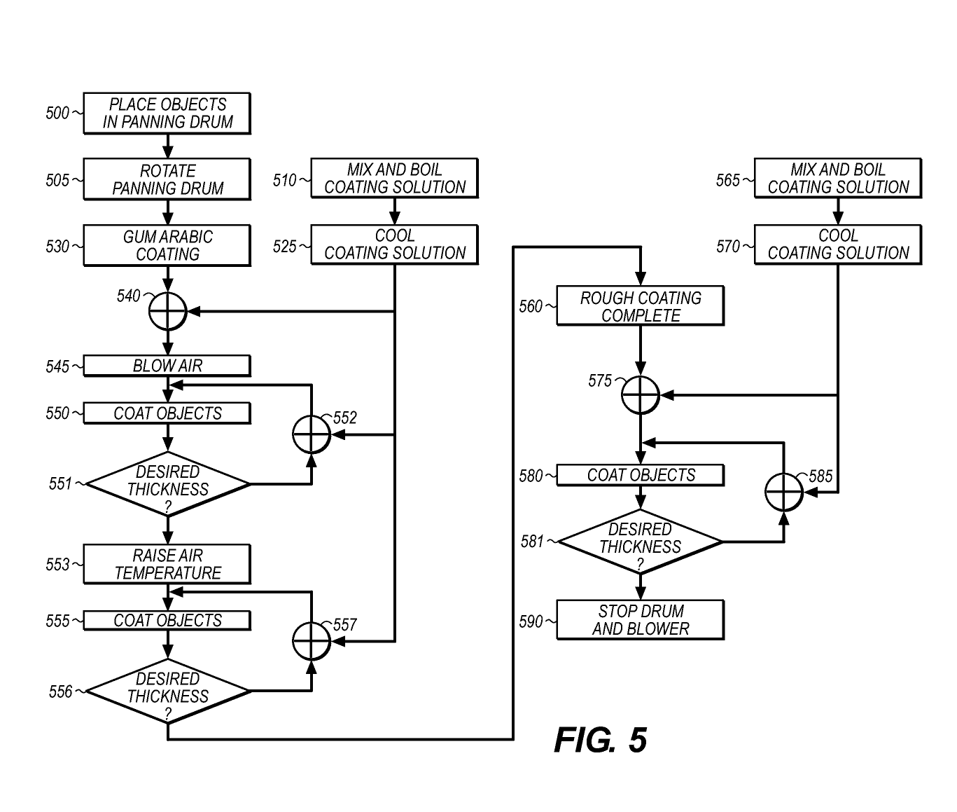

The steps of an embodiment for panning hollow molded chocolate objects 320 are shown in FIG. 5. In step 500, hollow molded chocolate objects 320 are placed in panning drum 410. Panning drum 410 begins rotating in step 505. In step 530, Gum Arabic or a sugar solution is ladled into panning drum 410 so that walls 310 of hollow molded chocolate objects 320 are sealed and solid chocolate 300 will not bleed into subsequent coatings. First coating solution 420, an aqueous sugar solution, is mixed and boiled in step 510. First coating solution 420 has a high sugar to water ratio. A high sugar to water ratio is created when the weight of sugar is higher than the weight of water used to create first coating solution 420. A low sugar to water ratio is created when the weight of water is higher than the weight of sugar used to create second coating solution 520. First coating solution 420 is heated until just boiling and then cooled in step 525. Because hollow molded chocolate objects 320 are being coated as opposed to solid molded chocolate objects, first coating solution 420 is cooled to about 70 degrees Fahrenheit instead of the standard 80 to 100 degrees used in conventional practice. In step 540, first coating solution 420 is added to panning drum 410 by means of vessel 430 or some other means well known in the art such as a nozzle.

With first coating solution 420 and hollow molded chocolate objects 320 inside panning drum 410, blower 440 begins cooling with 70 degree Fahrenheit air in step 545. In conventional practice, panning operations use 80 to 100 degree air, so blowers have been modified for the invention. The exterior surfaces of hollow molded chocolate objects 320 are coated in step 550. If the desired coating thickness is not detected in step 551, additional first coating solution 420 is added in step 552. Steps 550 and 552 are repeated until hollow molded chocolate objects 320 are coated with a plurality of rough sugar layers 350. In step 553, the sugar coating has become thick enough that the temperature of blower 440 can be raised. After rough sugar layers 350 have been created and the hollow molded chocolate objects 320 are partially coated, the temperature of air provided by the blower 440 is raised by heating elements within the blower to between 80 and 100 degrees so that the sugar coating will dry faster. The exterior surface of hollow molded chocolate objects 320, which had been partially coated, is now fully coated in step 555. Additional first coating solution 420 is added in step 557 if the desired coating thickness is not detected in step 556. Steps 555 and 557 are repeated until hollow molded chocolate objects 320 are coated with an additional plurality of rough layers 360. In step 560, rough sugar layers 350 and 360 have become thick enough that a finish layer can be applied.

Second coating solution 520, an aqueous sugar solution, is mixed and boiled in step 565. Coating solution 520 has a low sugar to water ratio. Coating solution 520 is heated until just boiling and then cooled in step 570. Because hollow molded chocolate objects 320 are already partially coated, coating solution 520 is cooled to the standard 80 to 100 degrees. In step 575, coating solution 520 is added to panning drum 410 by means of vessel 430 or some other means well known in the art such as a nozzle. Coating solution 520 acts to fill in the cracks of the rough coating and provides a finish sugar layer 370, rendering the conventional gloss step unnecessary. Hollow molded chocolate objects are coated in step 580. If the desired coating thickness is not detected in step 581, or if the desired finish texture has not been achieved, additional coating solution 520 is added in step 585. Steps 580 and 585 are repeated until hollow molded chocolate objects 320 are coated with a plurality of finish sugar layers 370. The total time for panning is two to three hours, with each coating step 550 and 580 taking 1 to 2 minutes for adding layers of sugar. In step 590, the coating operation is complete and blower 440 and panning drum 410 are stopped.

Hollow molded chocolate objects 320, now coated, are removed from panning drum 410 and are placed in crates to air dry for up to 24 hours. No glaze is applied. Because coated surface 380 of hollow molded chocolate objects 320 has no glaze applied, and because coated surface 380 comprises closely organized sugar crystals, surface writability is improved over conventional glazed coatings. The coated surface now accepts edible dye 630 from food coloring marker 620 with improved writability and with limited dye smearing. Edible dyes are generally water- and glycerin-based; among edible dyes that can be used favorably with the coated surface are those provided by the Color-A-Cookie Company, Islip, N.Y.

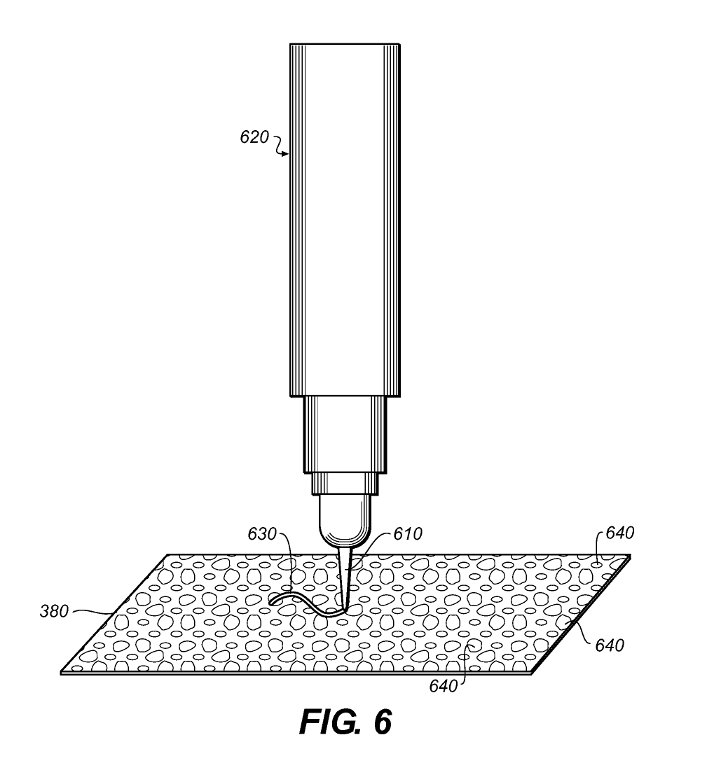

Coated surface 380 of hollow molded chocolate objects 320 has been shown to improve writability and minimize smearing. Overall time-to-colorfastness is significantly improved over that exhibited using conventional glazed surfaces. As shown in FIG. 6, when a food coloring marker 620 is brought into contact with coated surface 380, edible dye 630 is transferred from marker tip 610 to coated surface 380. Coated surface 380 of the hollow molded chocolate object 320 of the invention absorbs edible dye 630 from marker tip 610 almost immediately. Edible dye 630 penetrates coated surface 380 and the treated area of coated surface 380 becomes colorfast in a very short time, as compared with conventional methods. Testing has shown that edible dye 630 becomes colorfast in surface 380 in less than two seconds. In fact, edible dye 630 usually becomes colorfast in surface 380 in less than 0.5 seconds. By becoming colorfast quickly, writability is enhanced, and smearing is minimized. Testing in exactly the same manner with glazed chocolate objects formed using conventional practices has shown that the surface of these objects does not become colorfast in 5 seconds, nor does it become colorfast in 60 seconds. In fact, glazed chocolate objects do not become colorfast even 5 minutes after edible dye 630 has been transferred; a significant amount of drying time can be required.

In general, it would be expected that a rough surface would be less suitable for writing. However, the inventor has found that, contrary to expectation, the roughness of coated surface 380, when formed using the process described previously with reference to FIG. 5, improves writability and reduces smearing.

The inventor has found that surface 380 exhibits a considerable number of visible pores 640, also termed depressions, that can be seen without magnification. Visible pores 640 are departures from the visibly smooth surface of conventional glazed chocolate objects. Visible pores 640 are usually irregular in shape and distribution across coated surface 380, but can also be regularly shaped and regularly distributed. The depth of visible pores 640 has been measured to be in the range of 0.02 to 0.3 millimeters. Visible pores 640 provide increased roughness of coated surface 380 of hollow molded chocolate objects 320 of the present invention; this roughness appears to help minimize spreading of edible dye 630 by providing additional surface area for absorption of edible dye 630. Visible pores 630 also increase writability by providing coated surface 380 in a manner that effectively stimulates transfer of edible dye 630 from marker tip 610.

According to an aspect of the present invention, there is a coated hollow molded chocolate object with chocolate walls surrounding a gas-filled center; a rough sugar coating on the exterior surface of the chocolate walls and formed from a high sugar to water ratio solution; and a finish sugar coating on the exterior surface of the rough sugar coating formed from a low sugar to water ratio solution, wherein said finish sugar coating accepts edible dyes. At least a portion of the rough sugar coating is deposited on the hollow molded chocolate object without deforming the hollow molded chocolate object. The gas-filled center can be filled with air or other gas. The finish sugar coating minimizes migration of said edible dyes. There can be a plurality of rough sugar layers or a plurality of finish sugar layers.

The invention has been described in detail with particular reference to certain preferred embodiments thereof, but it will be understood that variations and modifications can be effected within the spirit and scope of the invention.

1. A chocolate confection having a surface that is coated to absorb an edible dye, the surface of the chocolate confection having a coarse sugar coating formed from one or more layers of a first solution having a high sugar to water ratio.

2. The chocolate confection according to claim 1, and further comprising a finish sugar coating applied over the coarse sugar coating and formed from one or more layers of a second solution having a low sugar to water ratio.

3. The chocolate confection of claim 1 wherein the chocolate confection has a hollow center.

4. The chocolate confection of claim 1 wherein the coated surface is unglazed.

5. The chocolate confection of claim 1 having markings from a water-based dye formed on the finish sugar coating.

6. The chocolate confection of claim 1 having markings from a glycerin-based dye formed on the finish sugar coating.

7. The chocolate confection of claim 1 wherein the finish sugar coating has a plurality of visible pores in a size range of 0.02 to 0.3 millimeters.

8. The chocolate confection of claim 1 wherein, by weight, the amount of sugar in the first solution exceeds the amount of water.

9. The chocolate confection of claim 1 wherein, by weight, the amount of water in the second solution exceeds the amount of sugar.

10. The chocolate confection of claim 1 wherein at least one of the coarse or the finish sugar coatings further comprise a colorant.

11. A method for forming a coated chocolate confection, the method comprising:
molding a chocolate object of a given shape;
sealing the surface of the molded object by applying gum arabic or a sugar solution and drying the sealed surface; and
applying a first coating solution to the sealed surface in one or more rough sugar layers, wherein the weight of sugar exceeds the weight of water in the first coating solution.

12. The method of claim 11, and further comprising the steps of:
applying a second, finish coating solution to the sealed surface in one or more layers, wherein the weight of water exceeds the weight of sugar in the second coating solution; and
air-drying the coated chocolate confection.

13. The method of claim 10 wherein sealing the surface and applying the first and second coating solutions are performed within a panning drum.

14. The method of claim 10 wherein molding the chocolate object comprises using a book mold.

15. The method of claim 10 wherein one or both of the first and second coating solutions further comprise a colorant.

16. The method of claim 10 wherein the first coating solution is cooled from near boiling to about 70 degrees F. for application to the surface.

17. The method of claim 14 further comprising checking the thickness of the rough sugar layers and increasing a blower air temperature above a threshold thickness.

18. The method of claim 10 further comprising writing upon the finish coating using an edible dye.

19. The chocolate confection of claim 10 wherein the chocolate confection has a hollow center.

20. A method for forming a coated chocolate confection, the method comprising:
forming a chocolate object of a given shape;
sealing the surface of the chocolate object by applying gum arabic or a sugar solution and drying the sealed surface;
applying a first coating solution to the sealed surface in one or more rough sugar layers, wherein the weight of sugar exceeds the weight of water in the first coating solution;
applying, to the one or more rough sugar layers, a second, finish coating solution in one or more finishing layers, wherein the weight of water exceeds the weight of sugar in the second coating solution; and
writing upon the applied finish coating using an edible dye.
